(19) United States
(12) Patent Application Publication
(10) Pub. No.: US 2024/0311492 A1
(43) Pub. Date: Sep. 19, 2024

(54) RESOURCE GROUP AUDITOR FOR PROTECTION UNITS IN DEVICE FABRIC

(71) Applicant: QUALCOMM Incorporated, San Diego, CA (US)

(72) Inventors: Srilatha TAPSE, Hyderabad (IN); Amit PRAKASH, Bangalore (IN); Anuj SANATHANAN, Hyderabad (IN)

(21) Appl. No.: 18/183,094

(22) Filed: Mar. 13, 2023

(51) Int. Cl. G06F 21/57

(52) U.S. Cl. CPC G06F 21/577; G06F 2221/034

(57) ABSTRACT

Systems and techniques are described herein for assessing paths between components and access control configurations or entities along paths. For example, a computing device (e.g., implementing a resource group auditor) can obtain a set of paths from access domains to targets. The computing device can assess the set of paths to obtain a first subset of the set of paths that are unsecured. The computing device can further assess a first portion of the set of paths that include one or more protection units to obtain a second subset of the set of paths that are path violation free. The computing device can assess a second portion of the set of paths that include the protection unit(s) to obtain a third subset of the set of paths that include a path violation. The computing device can generate a report that includes the first subset and the third subset.

### FIELD

The present disclosure generally relates to ensuring proper access control between components of a computing device connected by a device fabric (e.g., a network on a chip (NoC)). For example, aspects of the present disclosure relate to assessing paths between components and access control configurations or entities (e.g., protection units) along the paths.

### BACKGROUND

Devices often implement various techniques for access control. Access control may refer to the techniques implemented for ensuring that various entities executing on a device may only access targets (e.g., memory regions) for which an entity has appropriate access permissions. Such access control techniques often require complex configuration procedures that include various software entities of a device configuring various hardware components of the device (e.g., one or more protection units), such that accesses (e.g., reads and/or writes) issued to targets may be checked by the various hardware components before the access is allowed (or denied). Accessing targets may be performed, at least in part, using a device fabric (e.g., a set of one or more network on a chips (NoCs) and interconnects). There may be any number of paths in such a fabric between a target and an entity seeking to access the target. Such paths may include any number of protection units, each of which is configured to allow or deny a given access attempt. A valid configuration of such protection units ensures that the intended access control scheme is properly implemented for the device, such that various targets may be accessed by appropriate entities, while access to the targets is prevented for entities which are not intended to have access. However, validating a correct configuration of such an access control scheme may be difficult, as there may be any number of paths (e.g., tens, hundreds, thousands, etc.) in a device, each path may include any number of protection units between a target and an entity seeking to access the target, and each protection unit must be properly configured according to the access control scheme for the access control to be valid and as intended. Such validation of access control schemes is often difficult, must be performed at least partially manually, and cannot or does not occur until late in the design cycle of a device (e.g., making the validation and any possible corrective action more expensive to implement).

### SUMMARY

Systems and techniques are described herein for analyzing and auditing the configuration of resource groups of protection units implementing access control techniques for allowing or denying one or more access domains access to one or more targets.

According to at least one example, a process for auditing resource groups across protection units is provided. The process includes: obtaining, at a resource group auditor, a set of paths from a plurality of access domains to a plurality of targets; assessing, at the resource group auditor, the set of paths to obtain a first subset of the set of paths that are unsecured; assessing, at the resource group auditor, a first portion of the set of paths that include one or more protection units to obtain a second subset of the set of paths that are path violation free; assessing, at the resource group auditor, a second portion of the set of paths that include the one or more protection units to obtain a third subset of the set of paths that include a path violation; and generating, at the resource group auditor, a report that includes the first subset and the third subset.

In another illustrative example, an apparatus for auditing resource groups across protection units is provided. The apparatus includes at least one memory and at least one processor coupled to the at least one memory and configured to: obtain a set of paths from a plurality of access domains to a plurality of targets; assess the set of paths to obtain a first subset of the set of paths that are unsecured; assess a first portion of the set of paths that include one or more protection units to obtain a second subset of the set of paths that are path violation free; assess a second portion of the set of paths that include the one or more protection units to obtain a third subset of the set of paths that include a path violation; and generate a report that includes the first subset and the third subset.

In another illustrative example, a non-transitory computer-readable medium is provided that has stored thereon instructions that, when executed by at least one processor, cause the at least one processor to: obtain a set of paths from a plurality of access domains to a plurality of targets; assess the set of paths to obtain a first subset of the set of paths that are unsecured; assess a first portion of the set of paths that include one or more protection units to obtain a second subset of the set of paths that are path violation free; assess a second portion of the set of paths that include the one or more protection units to obtain a third subset of the set of paths that include a path violation; and generate a report that includes the first subset and the third subset.

In another illustrative example, an apparatus for auditing resource groups across protection units, the apparatus comprising: means for obtaining a set of paths from a plurality of access domains to a plurality of targets; means for assessing the set of paths to obtain a first subset of the set of paths that are unsecured; means for assessing a first portion of the set of paths that include one or more protection units to obtain a second subset of the set of paths that are path violation free; means for assessing a second portion of the set of paths that include the one or more protection units to obtain a third subset of the set of paths that include a path violation; and means for generating a report that includes the first subset and the third subset.

In some aspects, one or more of the apparatuses described herein is, is part of, and/or includes a mobile or wireless communication device (e.g., a mobile telephone or other mobile device), an extended reality (XR) device or system (e.g., a virtual reality (VR) device, an augmented reality (AR) device, or a mixed reality (MR) device), a wearable device (e.g., a network-connected watch or other wearable device), a vehicle or a computing device or component of a vehicle, a camera, a personal computer, a laptop computer, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), a system-on-a-chip (SoC), any combination thereof, and/or other type of device. In some aspects, the apparatus(es) include(s) a display for displaying one or more images, notifications, and/or other displayable data. In some aspects, the apparatus(es) include(s) can include one or more sensors (e.g., one or more RF sensors), such as one or more gyroscopes, one or more gyrometers, one or more accelerometers, any combination thereof, and/or other sensor(s).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating certain components of a computing device, in accordance with some examples;

FIG. 2 is a block diagram illustrating an environment that includes a computing device, a resource group auditor, and a resource group catalog data structure, in accordance with one or more examples described herein;

FIG. 3 illustrates an example of an environment that includes a set of paths between access domains and targets to be analyzed by a resource group auditor, in accordance with one or more examples described herein;

FIG. 4 is a flow diagram illustrating an example of a process for auditing resource groups across protection units, in accordance with one or more examples described herein;

FIG. 5 is a diagram illustrating an example of a computing system for implementing certain aspects described herein.

### DETAILED DESCRIPTION

Certain aspects and examples of this disclosure are provided below. Some of these aspects and examples may be applied independently and some of them may be applied in combination, as would be apparent to those of skill in the art. In the following description, for the purposes of explanation, specific details are set forth in order to provide a thorough understanding of examples of the application. However, it will be apparent that various examples may be practiced without these specific details. The figures and description are not intended to be restrictive. Additionally, certain details known to those of ordinary skill in the art may be omitted to avoid obscuring the description.

In the below description of the figures, any component described with regard to a figure, in various examples described herein, may be equivalent to one or more like-named (or numbered) components described with regard to any other figure. For brevity, descriptions of these components may not be wholly repeated with regard to each figure. Thus, each and every example of the components of each figure is incorporated by reference and assumed to be optionally present within every other figure having one or more like-named components. Additionally, in accordance with various examples described herein, any description of the components of a figure is to be interpreted as an optional example, which may be implemented in addition to, in conjunction with, or in place of the examples described with regard to a corresponding like-named component in any other figure.

The ensuing description provides illustrative examples only, and is not intended to limit the scope, applicability, or configuration of the disclosure. Rather, the ensuing description of the illustrative examples will provide those skilled in the art with an enabling description for implementing an exemplary example. It should be understood that various changes may be made in the function and arrangement of elements without departing from the spirit and scope of the application as set forth in the appended claims.

As used herein, the phrase operatively connected, or operative connection (or any variation thereof), means that there exists between elements/components/devices, etc. a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection. Additionally, operatively connected devices and/or components may exchange things, and/or may inadvertently share things, other than information, such as, for example, electrical current, radio frequency signals, power supply interference, interference due to proximity, interference due to re-use of the same wire and/or physical medium, interference due to re-use of the same register and/or other logical medium, etc.

Systems, apparatuses, processes (also referred to as methods), and computer-readable media (collectively referred to as “systems and techniques”) are described herein for analyzing and auditing the configuration of resource groups on protection units within a device fabric operatively connecting one or more entities within one or more access domains to one or more target resources.

In certain scenarios, devices (e.g., computing devices, mobile devices, system-on-a-chip (SoC) devices, etc.) implement various techniques for access control for various engines in various access domains to access targets, or regions therein. An access domain may be a group of one or more engines that have the same or similar access permissions for accessing one or more targets. An engine may be any entity (e.g., operating system, application, processing element, direct memory access (DMA) engine, etc.) that is configured to generate read and/or write transactions. A target may be any device, component, etc. (e.g., memory devices (e.g., random access memory (RAM)), input/output (I/O) devices, memory-mapped I/O devices or regions, port-mapped I/O devices or regions, registers, etc.) that is configured to have data written to and/or read from the device, component, etc. A target may have locations (e.g., identified by addresses) to which data may be written to, read from, and/or otherwise accessed and/or operated on. A set of such locations may be referred to as a region or address range of a target. Access control may refer to techniques by which the ability of engines in access domains to access one or more targets and/or target regions is controlled, such that only certain engines and/or access domains may access certain targets.

As an example, to implement access control for several access domains, each including a number of engines configured to perform read, write, and/or other operations, an entity (e.g., a trust zone, a trusted management entity, a trusted platform module, a security element, etc.) may be used to configure one or more protection units that control access to target resources by, for example, configuring the one or more protection units to include associations between the one or more target resources for which access is controlled by the protection units and the various access domains and/or engines therein that have appropriate permissions to access the various target resources.

In some examples, a computing device includes a device fabric connecting the entities within access domains to target resources. As an example, any number of NoCs may exist within an SoC for providing interconnectivity between components. Such NoCs may be connected to one another, to entities in access domains, and/or to targets using any number of interconnections in any configuration. As such, there may be any number of paths (e.g., operative connections) between entities in access domains and targets of the device. Each NoC in such a fabric may include any number of protection units. Each protection unit may be configured with associations between targets, or regions thereof, and access domains for which access to a given target is allowed. The architecture of the paths through the fabric from entities in access domains to targets may be designed by a fabric designer and intended to provide an operative connection between relevant components of a device. Configuration of the protection units along such paths may be performed according to a resource group catalog data structure (e.g., a database) that includes resource group definitions (e.g., associations between access domains and targets and/or target regions) for the protection units. The resource group catalog data structure may be used as at least part of a scheme for implementing access control for a computing device.

In some examples, a valid configuration of resource groups on protection units within a device fabric is a configuration that correctly establishes the intended access control scheme by ensuring that protection units along paths between entities in access domains and targets are configured to allow certain access domains to access certain targets based on associations in the protection units that associate the access domains with the relevant targets. In some examples, each protection unit along a given path must be so configured for information (e.g., data, access requests, etc.) to propagate between an access domain and a target and/or target region.

In some examples, to validate the configuration of the protection units as correctly implementing the intended access control scheme, a resource group auditor is provided. In some examples, a resource group auditor is a component included in and/or otherwise operatively connected to a computing device with a fabric that includes protection units, and to a resource group catalog data structure. In some examples, a resource group auditor obtains a set of all paths within a fabric between entities in access domains and targets that such entities may access. As an example, such a set of paths may be obtained by assessing the interconnection configuration of entities in access domains, NoCs, connections between NoCs, and targets. As another example, such a set of paths may be obtained from an architecture specification for a device. In some examples, a resource group catalog data structure is a data structure of any type (e.g., a database) that includes intended associations between access domains and target resources (e.g., targets and/or target regions) for the protection units of a computing device. In some examples, a resource group auditor obtains the relevant access control information from the resource group catalog data structure.

In some examples, the resource group auditor uses the set of paths and the resource group associations to perform an iterative traversal of the paths to determine if the path is unsecured (e.g., includes no protection units) or secured (e.g., includes one or more protection units). In some examples, the subset of the set of paths that are unsecured are one portion of a set of information that will be included in a report generated by the resource group auditor.

In some examples, the paths identified as secured paths are subjected to further analysis by the resource group auditor. In some examples, the resource group auditor performs a traversal of the paths using the resource group associations from the resource group catalog data structure. As an example, the resource group auditor may assess a path between an entity in an access domain and one or more target resources associated with the access domain by assessing the resource group configuration of each protection unit along the path. The traversal may be performed along the path from the entity in the access domain to the target resources, from the target resources to the entity in the access domain, and/or in both directions.

For each protection unit, the resource group auditor may determine whether the protection unit is configured to allow a particular access domain access to particular target resources. In some examples, if all protection units on a given path are properly configured to allow an access domain access to target resources in compliance with the access control policy of the computing device, the path may be considered as being path violation free (e.g., there are no path violations). As an example, a path violation may exist when one or more protection units on a given path include conflicting definitions for resource groups. For example, one protection unit may be configured to allow an access domain to access a particular target resource, which is intended per the access control policy, while another protection unit along the same path is not configured to allow the same access. In some examples, such a conflict may prevent information from propagating between an entity in the access domain and the target resource, which may reduce or prevent the computing device from operating as expected. Such conflicts may arise for any reason. As an example, a new access domain may be added to a computing device, or an new entity may be added to one or more existing access domains, and the reconfiguration of the protection units of the device may be performed improperly, leading to such a conflict.

In some aspects, a second subset of the set of paths that are path violation free do not require further analysis, and a third subset of the set of paths that include violations may require further analysis. In some examples, to facilitate such further analysis, the resource group auditor may generate a report that includes at least the subset of the set of paths that are unsecured, and the subset of the set of paths that include path violations. Such a report may be provided, for example, to an entity (e.g., and access control administrator) to determine whether the paths of the two subsets are properly configured. In some examples, an access control administrator may be any entity (e.g., software or firmware executing on a hardware device, a person, etc.).

In some cases, a particular path being unsecured may be intended. As an example, it may be a planned part of an access control scheme that a particular target resource does not require access control, or that a given entity of an access domain may access one or more target resources without being subjected to access control checks at one or more protection units. In some examples, a path being unsecured may be an error in the designed architecture. Upon discovering such an error, a corrective action may be taken, such as changing the architecture to include protection units along the previously unsecured path, reconfiguring the path to propagate through one or more existing protection units, etc.

In some examples, a particular conflict between protection units may be intended. As an example, a protection unit early in a path (e.g., closer to an entity in an access domain) may be properly configured to allow accesses from the access domain to pass, and there may be multiple paths coming out of the protection unit, some of which are intended as valid paths for the access request, and some of which are not. Thus, the conflict between certain protection units may be an intended part of the access control scheme. In some examples, a particular conflict between protection units on a path may be unintended. As an example, a particular access domain may require access to a particular target resource. In some examples, to facilitate such access, each protection unit along a path between an entity in the access domain and the target resource should be configured with an association between the access domain and the target resource. If any one or more of the protection units along such a path do not include such an association, the conflicting resource group configurations of the protection units of the path may cause the access to the target resource to be denied for the access domain, which may be unintended (e.g., not in compliance with the access control scheme being implemented). In some examples, when a conflict between protection units on a particular path is not intended, the path may be considered as having a path violation. Upon discovering such an error, a corrective action may be performed. In some examples, such a corrective action may include updating one or more configurations for one or more protection units in order to resolve the conflict, thereby allowing the intended access.

In some cases, the aforementioned traversals of paths of the set of paths are performed iteratively until all paths in the set of paths have been analyzed to determine if the paths are unsecured, path violation free, or include a path violation (e.g., access is not allowed along the path for a given access domain to a particular target resource). The traversal may be performed at any level of granularity. As an example, for a given path, a first access domain may be associated with a particular target resource in a first protection unit along the path. The target resource may include a range of addresses corresponding to discrete portions of the target resource (e.g., memory address ranges). Such address ranges may be divided into resource group portions of any size (e.g., four kilobytes). For each resource group portion (e.g., a subset of an address range of a target resource), all subsequent protection units along the path to the target resource are assessed to determine if the protection unit is configured to allow the access domain to access the resource group portion. If the subsequent protection units are not so configured, the path may be marked as having a path violation. If the subsequent protection units are configured to allow the access domain to access the resource group portion, then the analysis may continue to the next resource group portion until all resource group portions associated with a particular access domain have been checked. This process may be repeated for each access domain configured on the initial protection unit of the traversal until all resource group portions of all access domains for the protection unit have been analyzed. The per-protection unit analysis may be performed for each protection unit being used to implement the access control scheme. As discussed above, the traversal may begin with protection units adjacent to the entities of the access domains, and progress through each subsequent level of the fabric until the target resources are reached. Additionally or alternatively, the traversal may be performed in reverse, starting with protection units adjacent to the target resources, and progressing through the levels of the fabric until the entities of the access domains are reached.

In some examples, the above-described analysis may result in a subset of the set of paths that are unsecured, a subset of the set of paths that are secured and have no path violations (e.g., are path violation free), and/or a subset of the set of paths that are secured, but that include path violations. In some examples, at least the subset of unsecured paths and the subset having path violations are included as a part of a report generated by a resource group auditor that may be provided to an entity responsible for ensuring proper implementation of an access control policy for a computing device. In some examples, the entity assesses the report generated by the resource group auditor to determine whether the unsecured paths and paths with violations are configured as intended or not, and to perform one or more corrective actions for any unsecured path or path with a violation that is misconfigured.

Examples described herein may address the need to improve access control policy implementation by providing a mechanism for identifying potential problems with access control caused by misconfiguration of resource group definitions for protection units. In some examples, the potential problems are identified earlier in the design cycle of a computing device, which may reduce the cost and/or complexity of implementing corrective actions to resolve the errors in the configuration implementing the access control policy.

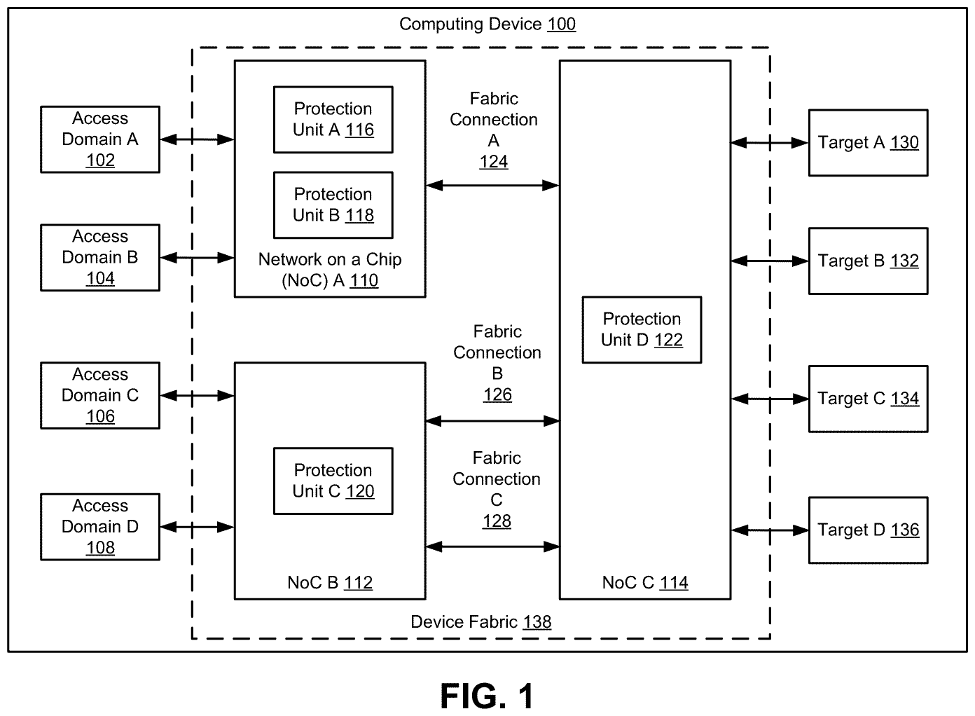

Various aspects of the techniques described herein will be discussed below with respect to the figures. FIG. 1 is a block diagram illustrating an example of a computing device 100. As shown, the computing device 100 includes any number of access domains (e.g., the access domain A 102, the access domain B 104, the access domain C 106, the access domain D 108), any number of targets, (e.g., the target A 130, the target B 132, the target C 134, the target D 136), and any number of NoCs (e.g., the NoC A 110, the NoC B 112, the NoC C 114). The NoCs (e.g., 110, 112, 114) may include any number of protection units (e.g., the protection unit A 116, the protection unit B 118, the protection unit C 120, the protection unit D 122). The NoCs (e.g., 112, 114, 116) may be interconnected via any number of fabric connections (e.g., the fabric connection A 124, the fabric connection B 126, the fabric connection C 128). The NoCs (e.g., 112, 112, 114) and the fabric connections (e.g., 124, 126, 128) may be part of a device fabric (e.g., the device fabric 138) Each of these components is described below.

The computing device 100 is any device, portion of a device, or any set of devices capable of electronically processing instructions and may include, but is not limited to, any of the following: one or more processors (e.g. components that include integrated circuitry, memory, input and output device(s) (not shown), non-volatile storage hardware, one or more physical interfaces (e.g., input/output (I/O) interfaces), any number of other hardware components (not shown), and/or any combination thereof. Examples of computing devices include, but are not limited to, a mobile device (e.g., laptop computer, smart phone, personal digital assistant, tablet computer, automobile computing system, and/or any other mobile computing device), an Internet of Things (IoT) device, a server (e.g., a blade-server in a blade-server chassis, a rack server in a rack, etc.), a desktop computer, a storage device (e.g., a disk drive array, a fibre channel storage device, an Internet Small Computer Systems Interface (iSCSI) storage device, a tape storage device, a flash storage array, a network attached storage device, etc.), a network device (e.g., switch, router, multi-layer switch, etc.), a wearable device (e.g., a network-connected watch or smartwatch, or other wearable device), a robotic device, a smart television, a smart appliance, an extended reality (XR) device (e.g., augmented reality, virtual reality, etc.), any device that includes one or more SoCs, and/or any other type of computing device with the aforementioned requirements. In one or more examples, any or all of the aforementioned examples may be combined to create a system of such devices, which may collectively be referred to as a computing device. Other types of computing devices may be used without departing from the scope of examples described herein.

In some examples, the computing device 100 includes any number of access domains (e.g., 102, 104, 106, 108). In some examples, an access domain is a set of one or more entities that have the same or similar security permissions, at least in regards to accessing one or more targets (discussed below). In some examples, an entity of an access domain (not shown) is any entity executing using resources of the computing device 100 and configured to request operations (e.g., read operations, write operations, etc.) to be performed using targets (e.g., 130, 132, 134, 136). A given entity may have an exclusive access domain (e.g., an access domain that does not include other entities), be part of an access domain that includes one or more other entities (e.g., when two or more entities require access to the same target resources to perform certain functionality of the computing device), and/or may be part of any number of separate access domains. Examples of an entity of an access domain may include, but are not limited to, an operating system, an application, a service, a process, a processing element (e.g., a particular processor), a direct memory access (DMA) engine, etc.

In some examples, an entity of an access domain may perform operations using a processor (not shown). In some examples, a processor is any component that includes circuitry for executing instructions (e.g., of a computer program). As an example, such circuitry may be integrated circuitry implemented, at least in part, using transistors implementing such components as arithmetic logic units, control units, logic gates, registers, first-in, first-out (FIFO) buffers, data and control buffers, etc. In some examples, the processor may include additional components, such as, for example, cache memory. In some examples, a processor retrieves and decodes instructions, which are then executed. Execution of instructions may include operating on data, which may include reading and/or writing data. In some examples, the instructions and data used by a processor are stored in the memory of the computing device 100. A processor may perform various operations for executing software, such as operating systems, applications, etc. The processor may cause data to be written from memory to storage of the computing device 100 and/or cause data to be read from storage via the memory. Examples of processors include, but are not limited to, central processing units (CPUs), graphics processing units (GPUs), neural processing units, tensor processing units, display processing units, digital signal processors (DSPs), finite state machines, etc. A processor may be operatively connected to a memory device and/or any storage of the computing device 100.

Although FIG. 1 shows the computing device 100 as having four access domains 102, 104, 106, and 108, the computing device 100 may have any number of access domains without departing from the scope of examples described herein. Additionally, although not shown in FIG. 1, all or any portion of the access domains 102, 104, 106, and 108 may be operatively connected to one another to, for example, exchange information, request services from one another, etc.

In some examples, each access domain (e.g., 102, 104, 106, 108) is operatively connected to at least one NoC (e.g., 110, 112, 114) of the device fabric 138 includes, at least, a collection of one or more NoCs, and any device fabric connections (e.g., 124, 126, 128). The exemplary device fabric 138 shown in FIG. 1 includes three NoCs (110, 112, 114) and three fabric connections (124, 126, 128). As shown in FIG. 1, the fabric connection A 124 provides an operative connection between the NoC A 110 and the NoC C 114, the fabric connection B 126 provides an operative connection between NoC B 112 and the NoC C 114, and the fabric connection C provides an operative connection between the NoC B 112 and the NoC C 114.

In some examples, the device fabric includes any number of NoCs (e.g., 110, 112, 114). In some examples, a NoC (e.g., 110, 112, 114) is any hardware, software, firmware, or any combination thereof configured to implement connectivity between various components, modules, etc. of a computing device. As an example, a computing device may be or include a SoC, and the SoC may include any number of NoCs for providing connectivity between any number of access domains (e.g., 102, 104, 106, 108) and any number of targets (e.g., 130, 132, 134, 136). An NoC (e.g., 110, 112, 114) may avoid a requirement for each signal in a computing device (e.g., a SoC) from requiring a dedicated point-to-point connection by using networking concepts to route receive signals to appropriate destinations using a set of paths within a device fabric (e.g., 138) implemented using one or more NoCs (e.g., 110, 112, 114) and any number of fabric connections (e.g., 124, 126, 128). Although FIG. 1 shows the device fabric 138 and including three NoCs (110, 112, 114) interconnected in a particular way by three fabric connections (124, 126, 128), one of ordinary skill in the relevant art, having the benefit of this Detailed Description, will appreciate that a device fabric may include any number of NoCs, and any number of fabric connections, organized in any configuration, for providing any number of paths through the device fabric.

In some examples, each NoC (e.g., 110, 112, 114) includes any number of protection units (e.g., 116, 118, 120, 122). As shown in FIG. 1, the NoC A 110 includes the protection unit A 116 and the protection unit B 118, the NoC B 112 include the protection unit C 120, and the NoC 114 includes the protection unit D 122. In some examples, a protection unit (e.g., 116, 118, 120, 122) is any hardware, software, firmware, or any combination thereof that is configured to provide protection (e.g., access control) for any number of targets (e.g., 130, 132, 134, 136). A protection unit (e.g., 116, 118, 120, 122) may be configured to operate in any number of modes, with each mode providing protection from unauthorized access to certain types of target resources.

As an example, a protection unit (e.g., 116, 118, 120, 122) may include a memory protection unit mode for protecting various memory devices and regions therein, a register protection unit mode for protecting any number of registers of the computing device 100, and/or an address protection unit mode for protecting any number of fragmented or contiguous sets of addresses corresponding to target regions of various targets (e.g., 118, 120, 122). Other modes may be implemented on a protection unit (e.g., 116, 118, 120, 122) without departing from the scope of examples described herein. The protection unit may be operatively connected to an number of entities in any number of access domains (e.g., 102, 104, 106, 108), to any number of targets (e.g., 130, 132, 134, 136), and/or to any number of other protection units of a device fabric (e.g., the device fabric 138) in any number of NoCs (e.g., 110, 112, 114).

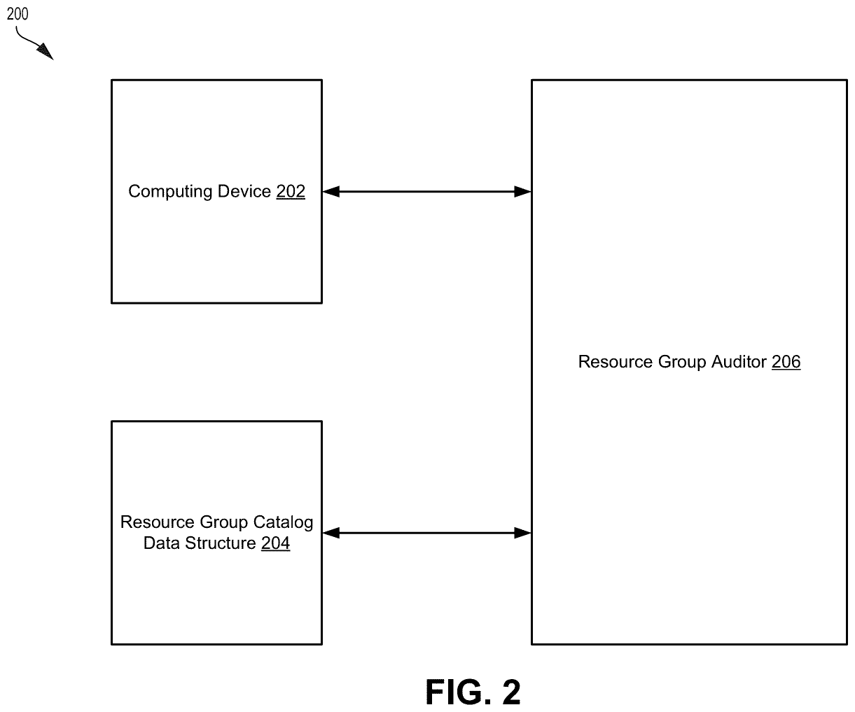

A protection unit (e.g., 116, 118, 120, 122) may be controlled, configured, re-configured, etc., at least in part, by another entity of the computing device 100, such as, for example, a trust zone entity, a trusted platform module, a security element, another hardware element, a management engine, etc. In some examples, such an entity may configure the protection units (e.g., 116, 118, 120, 122) according to an access control policy for a computing device. As an example, an access control policy may define intended associations between access domains and resource groups including one or more target resources, which may be stored in a resource group catalog data structure (discussed further in the description of FIG. 2, below), and a trust zone entity may be configured to configure the protection units (e.g., 116, 118, 120, 122) of the device fabric 138 according to the contents of the resource group catalog data structure.

Although FIG. 1 shows various NoCs (e.g., 110, 112, 114) as including a certain number of protection units, an NoC may include any number of protection units without departing from the scope of examples described herein.

In some examples, a protection unit (e.g., 116, 118, 120, 122) is a hardware component that is configured to provide access control protection for various target resources (e.g., memory, registers, I/O memory, etc.). In some examples, a protection unit (e.g., 116, 118, 120, 122) of the computing device 100 controls, at least in part, access to a certain set of target resources (e.g., one or more memory devices, one or more sets of registers, any combination thereof, etc., such as targets 130, 132, 134, 136). To that end, a protection unit (e.g., 116, 118, 120, 122) may include any number of data structures, each including any number of entries, that include an association between target resources and access domains that have appropriate access permissions for the target resources per the access control policy of the computing device, as well as circuitry for processing operation requests based at least in part on the one or more data structures.

In some examples, when a protection unit (e.g., 116, 118, 120, 122) receives a request to allow access to a target (e.g., 130, 132, 134, 136), the protection unit performs a lookup in a data structure of the protection unit to determine if the data structure includes an entry associating the access domain associated with the request with the target resource for which access is being sought. As an example, a request may include that an entity of access domain A 102 seeks to access an address range within the target A 130. In such a scenario, the protection unit may assess its data structure to determine if it includes an entry allowing access domain A 102 to access the particular address range of the target A 130. In some examples, if such an entry exists, the protection unit may pass the request, otherwise, the request is denied. As discussed above, there may be any number of protection units on a path between an access domain and a target, and for an access to be allowed, each such protection unit must successfully pass the request based on its resource group configuration

In some examples, the computing device 100 includes any number of targets (e.g., 130, 132, 134, 136). In some examples, a target is any hardware, software, firmware, or any combination thereof that includes locations (e.g., identified by addresses) to which data may be written, from which data may be read, and/or at which any other operation may be performed (e.g., data is deleted, added, modified, updated, etc.). Examples of the targets 130, 132, 134, 136 include, but are not limited to, memory devices (e.g., random access memory (RAM)), input/output (I/O) devices, memory-mapped I/O devices or regions, port-mapped I/O devices or regions, registers, storage devices, etc. The target devices 130, 132, 134, 136 may be operatively connected to any number of protection units (e.g., 116, 118, 120, 122) of a device fabric (e.g., the device fabric 138). Although FIG. 1 shows the computing device having four targets 130, 132, 134, 136, the computing device 100 may have any number of targets without departing from the scope of examples described herein.

In some examples, a target (e.g., 118, 120, 122) may include any number of target regions (not shown). In some examples, a target region is any portion of the locations included in a target. As an example, a target region of a memory device may be a region that begins at a particular memory address and extends for a particular number of bytes, which may or may not be contiguous within the memory device. As another example, a target region may be a certain portion of a particular set of registers. Locations of targets (e.g., 118, 120, 122) may be used to perform various operations requested by engines of access domains (e.g., 102, 104, 106).

While FIG. 1 shows a certain number of components in a particular configuration, one of ordinary skill in the art will appreciate that the computing device 100 may include more components or fewer components, and/or components arranged in any number of alternate configurations without departing from the scope of examples described herein. Additionally, some or all of the components shown may be part of a single component, and any single component shown may be implemented as any number of discrete components. As an example, although FIG. 1 shows a variety of components as being included in the computing device 100, all or any portion of such components (e.g., access domains, targets, etc.) may be separate from and operatively connected to the computing device 100 without departing from the scope of examples described herein. As another example, a device fabric of a computing device may include any number of NoCs, connected in any number of ways by any number of fabric connections, with each NoC including any number of protection units. Additionally, although not shown in FIG. 1, one of ordinary skill in the art will appreciate that the computing device 100 may execute any amount or type of software or firmware (e.g., bootloaders, operating systems, hypervisors, virtual machines, computer applications, mobile device apps, etc.). Accordingly, examples disclosed herein should not be limited to the configuration of components shown in FIG. 1.

FIG. 2 is a block diagram illustrating an example environment 200 in accordance with one or more examples described herein. As shown in FIG. 2, the environment 200 include a computing device 202, a resource group catalog data structure 204, and a resource group auditor 206. Each of these components is described below.

In some examples, the computing device 202 is the same or substantially similar to the computing device 100 shown in FIG. 1 and described above. In some examples, a resource group catalog data structure is a data structure of any type (e.g., a database, a table, etc.) that includes entries that include associations between access domains and resource groups. As an example, the resource group catalog data structure may be a database that includes an entry for a particular access domain associated with a set of address ranges of various targets, where the set of address ranges is the resource group. The resource group catalog data structure 204 may be included in and/or operatively connected to the resource group auditor 206. In some examples, the entries of the resource group catalog data structure 204 represent at least a portion of an access control policy for a computing device (e.g., the computing device 202).

In some examples, the computing device 202 and the resource group catalog 204 are each operatively connected to the resource group auditor 206. In some examples, the resource group auditor 206 is any hardware (e.g., circuitry), software, firmware, or any combination thereof configured to analyze a set of paths between entities of access domains and targets. As an example, the resource group auditor may be all or any portion of a computing device. In some examples, such an analysis may identify a subset of the set of paths that are unsecured, a subset of the set of paths that are secured and path violation free, and/or a subset of the set of paths that include a path violation. In some examples, the resource group auditor 206 is further configured to generate a report that includes at least a the unsecured paths and the paths having path violations based on the analysis. Such a report may be in any form of presenting information. As an example, the report may include a simple listing of unsecured paths and paths with path violations, may include graphical representations of such a listing, etc.

In some examples, the resource group auditor 206 performs the aforementioned analysis by traversing the paths of the set of paths and analyzing the configuration of resource groups on each protection unit on a given path. The traversal may be performed along the path from the entity in the access domain to the target resources, from the target resources to the entity in the access domain, and/or in both directions. In some examples, the aforementioned traversals of paths of the set of paths are performed iteratively until all paths in the set of paths have been analyzed to determine if the paths are unsecured, path violation free, or include a path violation (e.g., access is not allowed along the path for a given access domain to a particular target resource). The traversal may be performed at any level of granularity. As an example, for a given path, a first access domain may be associated with a particular target resource in a first protection unit along the path. The target resource may include a range of addresses corresponding to discrete portions of the target resource (e.g., memory address ranges). Such address ranges may be divided into resource group portions of any size (e.g., four kilobytes). For each resource group portion (e.g., a subset of an address range of a target resource), all subsequent protection units along the path to the target resource are assessed to determine if the protection unit is configured to allow the access domain to access the resource group portion. If the subsequent protection units are not so configured, the path may be marked as having a path violation. If the subsequent protection units are configured to allow the access domain to access the resource group portion, then the analysis may continue to the next resource group portion until all resource group portions associated with a particular access domain have been checked. This process may be repeated for each access domain configured on the initial protection unit of the traversal until all resource group portions of all access domains for the protection unit have been analyzed. The per-protection unit analysis may be performed for each protection unit being used to implement the access control scheme. As discussed above, the traversal may begin with protection units adjacent to the entities of the access domains, and progress through each subsequent level of the fabric until the target resources are reached. Additionally or alternatively, the traversal may be performed in reverse, starting with protection units adjacent to the target resources, and progressing through the levels of the fabric until the entities of the access domains are reached.

While FIG. 2 shows a certain number of components in a particular configuration, one of ordinary skill in the art will appreciate that the environment 200 may include more components or fewer components, and/or components arranged in any number of alternate configurations without departing from the scope of examples described herein. Additionally, some or all of the components shown may be part of a single component, and any single component shown may be implemented as any number of discrete components. Additionally, although not shown in FIG. 2, one of ordinary skill in the art will appreciate that any component of the environment 200 may execute any amount or type of software or firmware (e.g., bootloaders, operating systems, hypervisors, virtual machines, computer applications, mobile device apps, etc.). Accordingly, examples disclosed herein should not be limited to the configuration of components shown in FIG. 2.

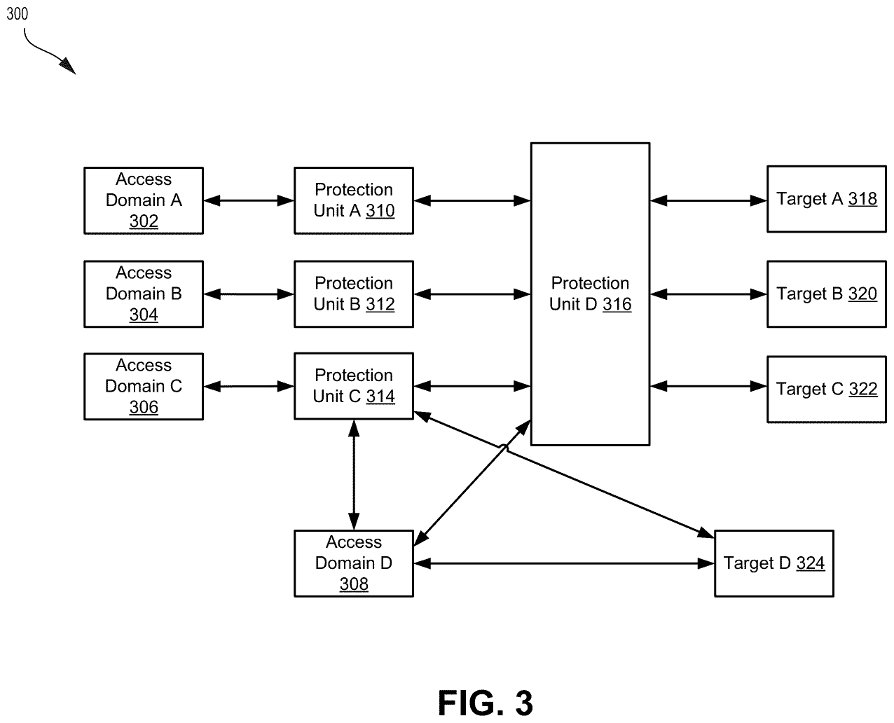

FIG. 3 illustrates an example environment 300 in accordance with one or more examples described herein. The following example is for explanatory purposes only and not intended to limit the scope of examples described herein. Additionally, while the example shows certain aspects of examples described herein, all possible aspects of such examples may not be illustrated in this particular example. FIG. 3 shows a simplified example intended to illustrate various concepts discussed herein. One or ordinary skill in the relevant art, having the benefit of this Detailed Description, will appreciate that a real-world example may be significantly more complex, having many more access domains, targets, and protection units, with each protection unit being configured for tens or hundreds of resource groups, all of which may form thousands of paths. Although not shown, the environment 300 may be within a computing device (e.g., the computing device 100 of FIG. 1, the computing device 202 of FIG. 2). Additionally, though not shown in FIG. 3, the environment 300 may be operatively connected to a resource group auditor (e.g., the resource group auditor 206 of FIG. 2), which may be operatively connected to a resource group catalog data structure (e.g., the resource group catalog data structure 204 of FIG. 2). FIG. 3 omits showing the computing device, the device fabric, and the NoCs of the device fabric in order to enhance the clarity of this example.

According to aspects described herein, in order to analyze the set of paths between access domains the resource group auditor obtains a set of paths for the environment 300. The set of paths includes all paths between an access domain (e.g., 302, 304, 306, 308) and a target (e.g., 318, 320, 322, 324).

As shown in FIG. 3, there exists a path between the access domain A 302 and the target A 318 via the protection unit A 310 and the protection unit D 316. Additionally, there exists a path between the access domain A 302 and the target B 320 via the protection unit A 310 and the protection unit D 316. Additionally, there exists a path between the access domain A 302 and the target C 322 via the protection unit A 310 and the protection unit D 316. Additionally, there exists a path between the access domain B 304 and the target A 318 via the protection unit b 312 and the protection unit D 316. Additionally, there exists a path between the access domain B 304 and the target B 320 via the protection unit B 312 and the protection unit D 316. Additionally, there exists a path between the access domain B 304 and the target C 322 via the protection unit B 312 and the protection unit D 316. Additionally, there exists a path between the access domain C 306 and the target A 318 via the protection unit C 314 and the protection unit D 316. Additionally, there exists a path between the access domain C 306 and the target B 320 via the protection unit C 314 and the protection unit D 316. Additionally, there exists a path between the access domain C 306 and the target C 322 via the protection unit C 314 and the protection unit D 316. Additionally, there exists a path between the access domain C 306 and the target D 324 via the protection unit C 314. Additionally, there exists a path between the access domain D 308 and the target A 318 via the protection unit D 316. Additionally, there exists a path between the access domain D 308 and the target B 320 via the protection unit D 316. Additionally, there exists a path between the access domain D 308 and the target C 322 via the protection unit D 316. Additionally, there exists a path between the access domain D 308 and the target D 324. A table summarizing these paths is below:

TABLE 1
Set of Paths of Environment 300

| Path | Access | | Protection Units |
|---|---|---|---|
| Number | Domain | Target | on the Path |
| 1 | A | A | A, D |
| 2 | A | B | A, D |
| 3 | A | C | A, D |
| 4 | B | A | B, D |
| 5 | B | B | B, D |
| 6 | B | C | B, D |
| 7 | C | A | C, D |
| 8 | C | B | C, D |
| 9 | C | C | C, D |
| 10 | C | D | C |
| 11 | D | A | D |
| 12 | D | B | D |
| 13 | D | C | D |
| 14 | D | D | C |
| 15 | D | D | None |

Table 1, above, shows a listing of the set of paths of environment 300. Table 1 includes path numbers for the sake of convenience in regard to this example. The set of paths may be alternatively represented in any way, and differentiated between using any scheme for identifying separate paths. As shown in Table 1, the environment 300 includes fifteen paths between access domains and targets.

In some examples, the resource group auditor analyzes the set of paths by performing a first analysis pass to identify any unsecured paths. In this example, the resource group auditor determines that there is one path, 15, that is unsecured. The resource group auditor thus adds path 15 to a list of unsecured paths as a first subset of the set of paths.

The resource group auditor then obtains the resource group configurations for each of the protection units from a resource group catalog data structure, which is used during a second pass of analysis for the remaining fourteen paths of the set of paths.

During the second pass, the resource group auditor determines that the protection unit A 310 is configured to allow the access domain A 302 to access the target A by determining that each four kilobyte resource group portion of an address range associated with target A 318 is configured in the protection unit A as accessible by the access domain A 302. Further each resource group portion is checked to determine that protection unit D is also configured to allow access from the access domain A 302 to the target A 318. A similar analysis is performed by the resource group auditor to determine that the protection unit A 310 and the protection unit D 316 are properly configured to allow access for the access domain A 302 to the target B 320 and the target C 322. Accordingly, path 1, path 2, and path 3 from Table 1 are added to a list of paths that are path violation free.

Also during the second pass of the analysis, the resource group auditor determines that the protection unit B is configured to allow the access domain B 304 to access the target A by determining that each four kilobyte resource group portion of an address range associated with target A 318 is configured in the protection unit B as accessible by the access domain A 302. Further each resource group portion is checked to determine that protection unit D is also configured to allow access from the access domain B 304 to the target A 318. A similar analysis performed by the resource group auditor determines that the protection unit B 312 and the protection unit D 316 are properly configured to allow access from the access domain A 302 to the target B 320. Accordingly, path 4 and path 5 from Table 1 are added to a list of paths that are path violation free. However, the analysis by the resource group auditor determines that although the protection unit B 312 is configured to allow access from the access domain B 304 to the target C 322, the protection unit D 316 is not configured to allow for such access. Accordingly, path 6 from Table 1 is added to a list of paths that include a path violation.

Also during the second pass of the analysis, the resource group auditor determines that the protection unit C is configured to allow the access domain C 306 to access the target C 322. However, the analysis further yields that the protection unit C 314 and the protection unit D 316 are both configured such that access from the access domain C 306 to the target A 318 and the target B 320 is not allowed. Accordingly, path 7 and path 8 from table 1 are added to a list of paths that include a path violation, and path 9 from Table 1 is added to the list of paths that are path violation free. The analysis also determines that the protection unit C is properly configured to allow access from the access domain C 306 to the target D 324. Accordingly, path 10 from Table 1 is added to the list of paths that are path violation free.

Also during the second pass of analysis by the resource group auditor determines that the protection unit C 314 and the protection unit D 316 are each properly configured to allow the access domain D 308 to access the target A 318, the target B 320, and the target C 322, and that the protection unit C 314 is properly configured to allow the access domain D 308 to access the target D 324. Accordingly, the path 11-14 are added to the list of paths that are path violation free.

After the above-described analysis is completed, the resource group auditor generates a report that includes the list of paths that are unsecured (path 15) and a list of paths that include a path violation (path 6, path 7, path 8). The report is provided to an access control administrator to assess whether the unsecured paths and the paths with violations are intended to be so. The access control administrator determines that the unsecured path 1 is an error. The access from the access domain D 308 to the target D 324 is intended, per the access control policy, to be controlled via the protection unit C, which exists in this example as path 14 from Table 1. Thus, the access control administrator performs a corrective action of removing the path 15, thereby removing the unintended unsecured path 15. The access control administrator further determines that the access domain B 304 should not normally have access to the target C 322, and thus the path violation of path 6, where the protection unit D 316 prevents the access is intended per the access control policy. In rare scenarios, the access domain B may require access to the target C 322, which is why the protection unit C 314 is configured to allow such an access, while the protection unit D 316 would require a proactive re-configuration to allow such an access, which may be performed if the rare scenario occurs in which such an access is required. Thus, no corrective action is required at this time for path 6. The access control administrator further determines that the lack of configuration in the protection unit C 314 and the protection unit D 316 for path 7 is intended per the access control policy, as the access domain C is not intended to have access to the target A 318. Thus, no corrective action is required for path 7. However, the access control administrator determines that the access domain C 306 should have access to the target B per the access control policy. Accordingly, the access control administrator performs a corrective action to re-configure the protection unit C 314 and the protection unit D 316 to allow such access

By performing the analysis as described above, the resource group auditor was able to determine that a corrective action is needed to remove the unsecured path 15, that a corrective action is needed to remove the path violation for path 8, and that the other paths with path violations in this example (path 6 and path 7) were as intended. Thus, the connectivity between access domains and targets may be updated earlier in the design process to ensure compliance with the access control policy for the computing device.

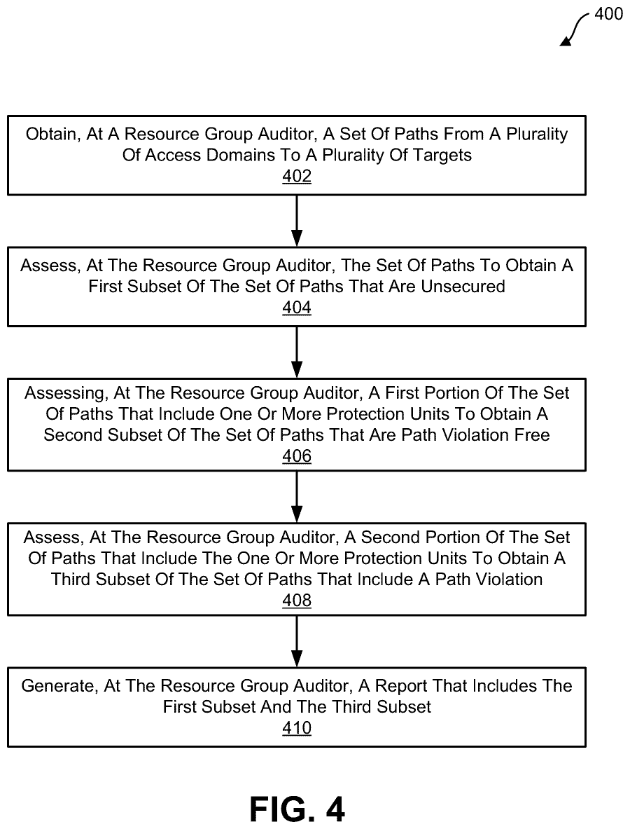

FIG. 4 is a flow diagram illustrating an example of a process 400 for auditing resource groups across protection units in accordance with one or more examples described herein. The process 400 may be performed, at least in part, for example, by the resource group auditor 206 of FIG. 2.

At block 402, the process 400 includes obtaining, at a resource group auditor, a set of paths from a plurality of access domains to a plurality of targets. Referring to FIG. 3 as an illustrative example, the set of paths can include all paths between an access domain (e.g., access domains 302, 304, 306, 308) and a target (e.g., targets 318, 320, 322, 324).

At block 404, the process 400 includes assessing, at the resource group auditor, the set of paths to obtain a first subset of the set of paths that are unsecured. In some cases, the process 400 can include determining the first subset based on determining that paths in the first subset are not secured by any protection units.

At block 406, the process 400 includes assessing, at the resource group auditor, a first portion of the set of paths that include one or more protection units to obtain a second subset of the set of paths that are path violation free. In some cases, the process 400 can include determining, by the resource group auditor, that the second subset includes paths that are path violation free based on determining that a data unit is allowed to pass from one of the plurality of access domains to one of the plurality of targets via one or more protection units. In some aspects, to assess the first portion of the set of paths to obtain the second subset, the process 400 can include removing the first subset from the set of paths to obtain a set of remaining paths and dividing a resource group associated with an access domain of the plurality of access domains into one or more resource group portions. The process 400 can further include performing a traversal between the access domain and a target of the plurality of targets for a resource group portion of the one or more resource group portions to determine that the target is accessible by the access domain within the resource group portion.

At block 408, the process 400 includes assessing, at the resource group auditor, a second portion of the set of paths that include the one or more protection units to obtain a third subset of the set of paths that include a path violation. In some aspects, the process 400 can include determining, by the resource group auditor, that the third subset includes paths having a violation based on determining that a conflict exists between a first protection unit and a second protection unit along a path of the third subset. In some cases, the conflict includes a determination that a particular access domain of the plurality of targets is allowed to access a particular target or the plurality of targets according to a first configuration of the first protection unit, and that the particular access domain is not allowed to access the particular target according to a second configuration of the second protection unit. In some aspects, to assess the second portion of the set of paths to obtain the third subset, the process 400 can include removing the first subset from the set of paths to obtain a set of remaining paths and dividing a resource group associated with an access domain of the plurality of access domains into one or more resource group portions. The process 400 can include performing a traversal between the access domain and a target of the plurality of targets for a resource group portion of the one or more resource group portions to determine that access to the target from the access domain is blocked by at least one protection unit.

At block 410, the process 400 includes generating, at the resource group auditor, a report that includes the first subset and the third subset. In some examples, the report is assessed by an access control administrator to determine whether to perform a corrective action. In some aspects, the report indicates that a portion of paths of the first subset and the third subset are incorrectly configured. In some cases, the process 400 can include performing a corrective action comprising a configuration update of at least one protection unit.

In some examples, the process 400, or any other process described herein may be performed by a computing device or apparatus, and/or one or more components therein and/or to which the computing device is operatively connected. As an example, the process 400 may be performed wholly or in part by the resource group auditor 206 shown in FIG. 2 and described above, which may execute on a computing device.

A computing device, may be, include, or be a component of any suitable device, such as a vehicle or a computing device of a vehicle (e.g., a driver monitoring system (DMS) of a vehicle), a mobile device (e.g., a mobile phone), a desktop computing device, a tablet computing device, a wearable device (e.g., a VR headset, an AR headset, AR glasses, a network-connected watch or smartwatch, or other wearable device), a server computer, a robotic device, a television, a smart speaker, a voice assistant device, a SoC, and/or any other device with the resource capabilities to perform the processes described herein, including the process 500 and/or other process described herein. In some cases, a computing device or apparatus (e.g., that includes a hardware identity impersonator) may include various components, such as one or more input devices, one or more output devices, one or more processors, one or more microprocessors, one or more microcomputers, one or more cameras, one or more sensors, and/or other component(s) that are configured to carry out the operations of processes described herein. In some examples, the computing device may include a display, a network interface configured to communicate and/or receive the data, an RF sensing component, any combination thereof, and/or other component(s). The network interface may be configured to communicate and/or receive Internet Protocol (IP) based data or other type of data.

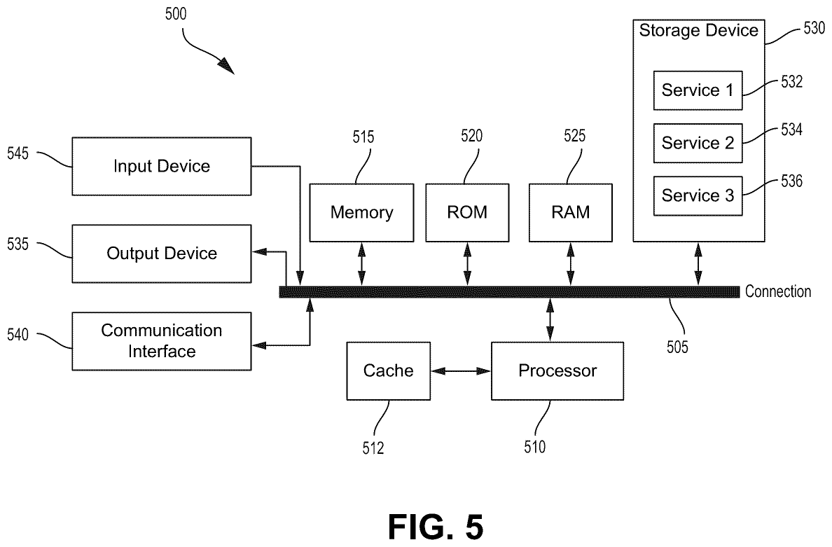

The components of a computing device (e.g., the computing device 100 of FIG. 1, the computing system 500 of FIG. 5) may be implemented, at least in part, in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), finite state machines, and/or other suitable electronic circuits), and/or can include and/or be implemented, at least in part, using computer software, firmware, or any combination thereof, to perform the various operations described herein.

The process 400 shown in FIG. 4 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 400, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 5 is a diagram illustrating an example of a system for implementing certain aspects of the present technology. In particular, FIG. 5 illustrates an example of computing system 500, which can be for example any computing device making up internal computing system, a remote computing system, a camera, or any component thereof in which the components of the system are in communication with each other using connection 505. Connection 505 can be a physical connection using a bus, or a direct connection into processor 510, such as in a chipset architecture. Connection 505 can also be a virtual connection, networked connection, or logical connection.

In some examples, computing system 500 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 500 includes at least one processing unit (CPU or processor) 510 and connection 505 that couples various system components including system memory 515, such as read-only memory (ROM) 520 and random access memory (RAM) 525 to processor 510. Computing system 500 can include a cache 512 of high-speed memory connected directly with, in close proximity to, or integrated as part of processor 510.

Processor 510 can include any general purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms or sensors, such as a microphone for speech (e.g., a user speaking), a touch-sensitive screen for gesture or graphical input (e.g., a user performing sign language symbols, a user shaking a phone, etc.), keyboard (e.g., a user pressing a key), mouse, motion input, a determination that a user is in a location indicated by a positioning system or modem sub-system, etc., which may be used to activate counters described in previous sections and enable/disable the asset transmission chain at any stage previously described. Computing system 500 can also include output device 535, which can be one or more of a number of output mechanisms. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash storage, memristor memory, any other solid-state memory, a compact disc read only memory (CD-ROM) optical disc, a rewritable compact disc (CD) optical disc, digital video disk (DVD) optical disc, a Blu-ray® disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof. The storage device 530 can include software instructions or code that can be executed by the processor 510 to cause the system 500 to perform a function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples and examples provided herein. However, it will be understood by one of ordinary skill in the art that the examples may be practiced without these specific details. For clarity of explanation, in some instances the present technology may be presented as including individual functional blocks including functional blocks comprising devices, device components, operations, steps, or routines in a method embodied in software, hardware, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional operations not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smartphones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm operations described in connection with the examples disclosed herein may be implemented as electronic hardware, computer software, firmware, or combinations thereof. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

### Illustrative Aspects of the Disclosure Include:

Aspect 1. A method for auditing resource groups across protection units, the method comprising: obtaining, at a resource group auditor, a set of paths from a plurality of access domains to a plurality of targets; assessing, at the resource group auditor, the set of paths to obtain a first subset of the set of paths that are unsecured; assessing, at the resource group auditor, a first portion of the set of paths that include one or more protection units to obtain a second subset of the set of paths that are path violation free; assessing, at the resource group auditor, a second portion of the set of paths that include the one or more protection units to obtain a third subset of the set of paths that include a path violation; and generating, at the resource group auditor, a report that includes the first subset and the third subset.

Aspect 2. The method of Aspect 1, further comprising determining the first subset based on determining that paths in the first subset are not secured by any protection units.

Aspect 3. The method of any of Aspects 1 or 2, further comprising determining, by the resource group auditor, that the second subset includes paths that are path violation free based on determining that a data unit is allowed to pass from one of the plurality of access domains to one of the plurality of targets via one or more protection units.

Aspect 4. The method of any of Aspects 1 to 3, further comprising determining, by the resource group auditor, that the third subset includes paths having a violation based on determining that a conflict exists between a first protection unit and a second protection unit along a path of the third subset.

Aspect 5. The method of Aspect 4, wherein the conflict comprises a determination that a particular access domain of the plurality of targets is allowed to access a particular target or the plurality of targets according to a first configuration of the first protection unit, and that the particular access domain is not allowed to access the particular target according to a second configuration of the second protection unit.

Aspect 6. The method of any of Aspects 1 to 5, wherein the report is assessed by an access control administrator to determine whether to perform a corrective action.

Aspect 7. The method of any of Aspects 1 to 6, wherein the report indicates that a portion of paths of the first subset and the third subset are incorrectly configured, and wherein the method further comprises performing a corrective action comprising a configuration update of at least one protection unit.

Aspect 8. The method of any of Aspects 1 to 7, wherein assessing the first portion of the set of paths to obtain the second subset comprises: removing the first subset from the set of paths to obtain a set of remaining paths; dividing a resource group associated with an access domain of the plurality of access domains into one or more resource group portions; and performing a traversal between the access domain and a target of the plurality of targets for a resource group portion of the one or more resource group portions to determine that the target is accessible by the access domain within the resource group portion.

Aspect 9. The method of any of Aspects 1 to 8, wherein assessing the second portion of the set of paths to obtain the third subset comprises: removing the first subset from the set of paths to obtain a set of remaining paths; dividing a resource group associated with an access domain of the plurality of access domains into one or more resource group portions; and performing a traversal between the access domain and a target of the plurality of targets for a resource group portion of the one or more resource group portions to determine that access to the target from the access domain is blocked by at least one protection unit.

Aspect 10. An apparatus for auditing resource groups across protection units, the apparatus comprising: at least one memory; and at least one processor coupled to the at least one memory and configured to: obtain a set of paths from a plurality of access domains to a plurality of targets; assess the set of paths to obtain a first subset of the set of paths that are unsecured; assess a first portion of the set of paths that include one or more protection units to obtain a second subset of the set of paths that are path violation free; assess a second portion of the set of paths that include the one or more protection units to obtain a third subset of the set of paths that include a path violation; and generate a report that includes the first subset and the third subset.

Aspect 11. The apparatus of Aspect 10, wherein the at least one processor is configured to determine the first subset based on determining that paths in the first subset are not secured by any protection units.

Aspect 12. The apparatus of any of Aspects 10 or 11, wherein the at least one processor is configured to determine that the second subset includes paths that are path violation free based on a determination that a data unit is allowed to pass from one of the plurality of access domains to one of the plurality of targets via one or more protection units.

Aspect 13. The apparatus of any of Aspects 10 to 12, wherein the at least one processor is configured to determine that the third subset includes paths having a violation based on a determination that a conflict exists between a first protection unit and a second protection unit along a path of the third subset.

Aspect 14. The apparatus of Aspect 13, wherein the conflict comprises a determination that a particular access domain of the plurality of targets is allowed to access a particular target or the plurality of targets according to a first configuration of the first protection unit, and that the particular access domain is not allowed to access the particular target according to a second configuration of the second protection unit.

Aspect 15. The apparatus of any of Aspects 10 to 14, wherein the report is assessed by an access control administrator to determine whether to perform a corrective action.

Aspect 16. The apparatus of any of Aspects 10 to 15, wherein the report indicates that a portion of paths of the first subset and the third subset are incorrectly configured, and wherein the at least one processor is configured to perform a corrective action comprising a configuration update of at least one protection unit.

Aspect 17. The apparatus of any of Aspects 10 to 16, wherein, to assess the first portion of the set of paths to obtain the second subset, the at least one processor is configured to: remove the first subset from the set of paths to obtain a set of remaining paths; divide a resource group associated with an access domain of the plurality of access domains into one or more resource group portions; and perform a traversal between the access domain and a target of the plurality of targets for a resource group portion of the one or more resource group portions to determine that the target is accessible by the access domain within the resource group portion.

Aspect 18. The apparatus of any of Aspects 10 to 17, wherein, to assess the second portion of the set of paths to obtain the third subset, the at least one processor is configured to: remove the first subset from the set of paths to obtain a set of remaining paths; divide a resource group associated with an access domain of the plurality of access domains into one or more resource group portions; and perform a traversal between the access domain and a target of the plurality of targets for a resource group portion of the one or more resource group portions to determine that access to the target from the access domain is blocked by at least one protection unit.

Aspect 19. A non-transitory computer-readable medium having stored thereon instructions that, when executed by at least one processor, cause the at least one processor to: obtain a set of paths from a plurality of access domains to a plurality of targets; assess the set of paths to obtain a first subset of the set of paths that are unsecured; assess a first portion of the set of paths that include one or more protection units to obtain a second subset of the set of paths that are path violation free; assess a second portion of the set of paths that include the one or more protection units to obtain a third subset of the set of paths that include a path violation; and generate a report that includes the first subset and the third subset.

Aspect 20. The computer-readable medium of Aspect 19, wherein the instructions, when executed by the at least one processor, cause the at least one processor to determine the first subset based on determining that paths in the first subset are not secured by any protection units.

Aspect 21. The computer-readable medium of any of Aspects 19 or 20, wherein the instructions, when executed by the at least one processor, cause the at least one processor to determine that the second subset includes paths that are path violation free based on a determination that a data unit is allowed to pass from one of the plurality of access domains to one of the plurality of targets via one or more protection units.

Aspect 22. The computer-readable medium of any of Aspects 19 to 21, wherein the instructions, when executed by the at least one processor, cause the at least one processor to determine that the third subset includes paths having a violation based on a determination that a conflict exists between a first protection unit and a second protection unit along a path of the third subset.

Aspect 23. The computer-readable medium of Aspect 22, wherein the conflict comprises a determination that a particular access domain of the plurality of targets is allowed to access a particular target or the plurality of targets according to a first configuration of the first protection unit, and that the particular access domain is not allowed to access the particular target according to a second configuration of the second protection unit.

Aspect 24. The computer-readable medium of any of Aspects 19 to 23, wherein the report is assessed by an access control administrator to determine whether to perform a corrective action.

Aspect 25. The computer-readable medium of any of Aspects 19 to 24, wherein the report indicates that a portion of paths of the first subset and the third subset are incorrectly configured, and wherein the instructions, when executed by the at least one processor, cause the at least one processor to perform a corrective action comprising a configuration update of at least one protection unit.

Aspect 26. The computer-readable medium of any of Aspects 19 to 25, wherein, to assess the first portion of the set of paths to obtain the second subset, the instructions, when executed by the at least one processor, cause the at least one processor to: remove the first subset from the set of paths to obtain a set of remaining paths; divide a resource group associated with an access domain of the plurality of access domains into one or more resource group portions; and perform a traversal between the access domain and a target of the plurality of targets for a resource group portion of the one or more resource group portions to determine that the target is accessible by the access domain within the resource group portion.

Aspect 27. The computer-readable medium of any of Aspects 19 to 26, wherein, to assess the second portion of the set of paths to obtain the third subset, the instructions, when executed by the at least one processor, cause the at least one processor to: remove the first subset from the set of paths to obtain a set of remaining paths; divide a resource group associated with an access domain of the plurality of access domains into one or more resource group portions; and perform a traversal between the access domain and a target of the plurality of targets for a resource group portion of the one or more resource group portions to determine that access to the target from the access domain is blocked by at least one protection unit.

Aspect 28. An apparatus for auditing resource groups across protection units, the apparatus comprising one or more means for performing operations according to any of Aspects 1 to 9.

What is claimed is:

1. A method for auditing resource groups across protection units, the method comprising:
obtaining, at a resource group auditor, a set of paths from a plurality of access domains to a plurality of targets;
assessing, at the resource group auditor, the set of paths to obtain a first subset of the set of paths that are unsecured;
assessing, at the resource group auditor, a first portion of the set of paths that include one or more protection units to obtain a second subset of the set of paths that are path violation free;
assessing, at the resource group auditor, a second portion of the set of paths that include the one or more protection units to obtain a third subset of the set of paths that include a path violation; and
generating, at the resource group auditor, a report that includes the first subset and the third subset.

2. The method of claim 1, further comprising determining the first subset based on determining that paths in the first subset are not secured by any protection units.

3. The method of claim 1, further comprising determining, by the resource group auditor, that the second subset includes paths that are path violation free based on determining that a data unit is allowed to pass from one of the plurality of access domains to one of the plurality of targets via one or more protection units.

4. The method of claim 1, further comprising determining, by the resource group auditor, that the third subset includes paths having a violation based on determining that a conflict exists between a first protection unit and a second protection unit along a path of the third subset.

5. The method of claim 4, wherein the conflict comprises a determination that a particular access domain of the plurality of targets is allowed to access a particular target or the plurality of targets according to a first configuration of the first protection unit, and that the particular access domain is not allowed to access the particular target according to a second configuration of the second protection unit.

6. The method of claim 1, wherein the report is assessed by an access control administrator to determine whether to perform a corrective action.

7. The method of claim 1, wherein the report indicates that a portion of paths of the first subset and the third subset are incorrectly configured, and wherein the method further comprises performing a corrective action comprising a configuration update of at least one protection unit.

8. The method of claim 1, wherein assessing the first portion of the set of paths to obtain the second subset comprises:
removing the first subset from the set of paths to obtain a set of remaining paths;
dividing a resource group associated with an access domain of the plurality of access domains into one or more resource group portions; and
performing a traversal between the access domain and a target of the plurality of targets for a resource group portion of the one or more resource group portions to determine that the target is accessible by the access domain within the resource group portion.

9. The method of claim 1, wherein assessing the second portion of the set of paths to obtain the third subset comprises:
removing the first subset from the set of paths to obtain a set of remaining paths;
dividing a resource group associated with an access domain of the plurality of access domains into one or more resource group portions; and
performing a traversal between the access domain and a target of the plurality of targets for a resource group portion of the one or more resource group portions to determine that access to the target from the access domain is blocked by at least one protection unit.

10. An apparatus for auditing resource groups across protection units, the apparatus comprising:
at least one memory; and
at least one processor coupled to the at least one memory and configured to:
obtain a set of paths from a plurality of access domains to a plurality of targets;
assess the set of paths to obtain a first subset of the set of paths that are unsecured;
assess a first portion of the set of paths that include one or more protection units to obtain a second subset of the set of paths that are path violation free;
assess a second portion of the set of paths that include the one or more protection units to obtain a third subset of the set of paths that include a path violation; and
generate a report that includes the first subset and the third subset.

11. The apparatus of claim 10, wherein the at least one processor is configured to determine the first subset based on determining that paths in the first subset are not secured by any protection units.

12. The apparatus of claim 10, wherein the at least one processor is configured to determine that the second subset includes paths that are path violation free based on a determination that a data unit is allowed to pass from one of the plurality of access domains to one of the plurality of targets via one or more protection units.

13. The apparatus of claim 10, wherein the at least one processor is configured to determine that the third subset includes paths having a violation based on a determination that a conflict exists between a first protection unit and a second protection unit along a path of the third subset.

14. The apparatus of claim 13, wherein the conflict comprises a determination that a particular access domain of the plurality of targets is allowed to access a particular target or the plurality of targets according to a first configuration of the first protection unit, and that the particular access domain is not allowed to access the particular target according to a second configuration of the second protection unit.

15. The apparatus of claim 10, wherein the report is assessed by an access control administrator to determine whether to perform a corrective action.

16. The apparatus of claim 10, wherein the report indicates that a portion of paths of the first subset and the third subset are incorrectly configured, and wherein the at least one processor is configured to perform a corrective action comprising a configuration update of at least one protection unit.

17. The apparatus of claim 10, wherein, to assess the first portion of the set of paths to obtain the second subset, the at least one processor is configured to:
remove the first subset from the set of paths to obtain a set of remaining paths;
divide a resource group associated with an access domain of the plurality of access domains into one or more resource group portions; and
perform a traversal between the access domain and a target of the plurality of targets for a resource group portion of the one or more resource group portions to determine that the target is accessible by the access domain within the resource group portion.

18. The apparatus of claim 10, wherein, to assess the second portion of the set of paths to obtain the third subset, the at least one processor is configured to:
remove the first subset from the set of paths to obtain a set of remaining paths;
divide a resource group associated with an access domain of the plurality of access domains into one or more resource group portions; and
perform a traversal between the access domain and a target of the plurality of targets for a resource group portion of the one or more resource group portions to determine that access to the target from the access domain is blocked by at least one protection unit.

19. A non-transitory computer-readable medium having stored thereon instructions that, when executed by at least one processor, cause the at least one processor to:
obtain a set of paths from a plurality of access domains to a plurality of targets;
assess the set of paths to obtain a first subset of the set of paths that are unsecured;
assess a first portion of the set of paths that include one or more protection units to obtain a second subset of the set of paths that are path violation free;
assess a second portion of the set of paths that include the one or more protection units to obtain a third subset of the set of paths that include a path violation; and
generate a report that includes the first subset and the third subset.

20. The computer-readable medium of claim 19, wherein the instructions, when executed by the at least one processor, cause the at least one processor to determine the first subset based on determining that paths in the first subset are not secured by any protection units.

21. The computer-readable medium of claim 19, wherein the instructions, when executed by the at least one processor, cause the at least one processor to determine that the second subset includes paths that are path violation free based on a determination that a data unit is allowed to pass from one of the plurality of access domains to one of the plurality of targets via one or more protection units.

22. The computer-readable medium of claim 19, wherein the instructions, when executed by the at least one processor, cause the at least one processor to determine that the third subset includes paths having a violation based on a determination that a conflict exists between a first protection unit and a second protection unit along a path of the third subset.

23. The computer-readable medium of claim 22, wherein the conflict comprises a determination that a particular access domain of the plurality of targets is allowed to access a particular target or the plurality of targets according to a first configuration of the first protection unit, and that the particular access domain is not allowed to access the particular target according to a second configuration of the second protection unit.

24. The computer-readable medium of claim 19, wherein the report is assessed by an access control administrator to determine whether to perform a corrective action.

25. The computer-readable medium of claim 19, wherein the report indicates that a portion of paths of the first subset and the third subset are incorrectly configured, and wherein the instructions, when executed by the at least one processor, cause the at least one processor to perform a corrective action comprising a configuration update of at least one protection unit.

26. The computer-readable medium of claim 19, wherein, to assess the first portion of the set of paths to obtain the second subset, the instructions, when executed by the at least one processor, cause the at least one processor to:
remove the first subset from the set of paths to obtain a set of remaining paths;
divide a resource group associated with an access domain of the plurality of access domains into one or more resource group portions; and
perform a traversal between the access domain and a target of the plurality of targets for a resource group portion of the one or more resource group portions to determine that the target is accessible by the access domain within the resource group portion.

27. The computer-readable medium of claim 19, wherein, to assess the second portion of the set of paths to obtain the third subset, the instructions, when executed by the at least one processor, cause the at least one processor to:
remove the first subset from the set of paths to obtain a set of remaining paths;
divide a resource group associated with an access domain of the plurality of access domains into one or more resource group portions; and
perform a traversal between the access domain and a target of the plurality of targets for a resource group portion of the one or more resource group portions to determine that access to the target from the access domain is blocked by at least one protection unit.
